(19) United States
(12) Patent Application Publication
(10) Pub. No.: US 2020/0110545 A1
(43) Pub. Date: Apr. 9, 2020

(54) MEMORY SYSTEM AND OPERATING METHOD THEREOF

(71) Applicant: SK hynix Inc., Gyeonggi-do (KR)

(72) Inventors: Young Guen CHOI, Gyeonggi-do (KR); Dong Ham YIM, Gyeonggi-do (KR)

(21) Appl. No.: 16/394,142

(22) Filed: Apr. 25, 2019

(30) Foreign Application Priority Data
Oct. 4, 2018 (KR) 10-2018-0118501

(51) Int. Cl. G06F 3/06; G06F 12/02

(52) U.S. Cl. CPC G06F 3/0616; G06F 3/0659; G06F 2212/1044; G06F 3/064; G06F 12/0253; G06F 3/0679

(57) ABSTRACT

The present disclosure relates to a memory system and an operating method thereof. The memory system includes a memory device including a plurality of memory blocks; and a controller configuring a plurality of super blocks by grouping the plurality of memory blocks and controlling overall operations of each of the plurality of super blocks, wherein the controller performs wear leveling on the basis of first erase counts, one for each of the plurality of super blocks, and wherein the controller performs wear leveling on the basis of second erase counts, one for each of memory blocks in a super block in which a memory block becomes a bad block, among the plurality of super blocks.

### CROSS-REFERENCE TO RELATED APPLICATION

The present application claims priority under 35 U.S.C. § 119(a) to Korean patent application number 10-2018-0118501, filed on Oct. 4, 2018, which is incorporated herein by reference in its entirety.

### BACKGROUND

### 1. Technical Field

Various embodiments relate generally to an electronic device and, more particularly, to a memory system and an operating method thereof.

### 2. Related Art

Recently, paradigm for computer environment has evolved into ubiquitous computing, which makes a computer system available at any time from any location. Therefore, the use of portable electronic devices, such as cellular phones, digital cameras, and laptop computers, has surged. A portable electronic device generally uses a memory system using a memory device, i.e., a data storage device. The data storage device serves as a main storage device or an auxiliary storage device of a portable electronic device.

Such data storage device used as a memory device has excellent stability and durability since it does not have any mechanical driving parts. In addition, the data storage device also enjoys very fast information access speed and low power consumption. Examples of a data storage device that may be embodied in a memory system to provide these advantages include a universal serial bus (USB) memory device, a memory card having various interfaces, and a solid state drive (SSD).

Memory devices are generally classified into volatile memory devices and non-volatile memory devices.

Non-volatile memory devices operate at relatively low write and read speeds, but they may retain stored data in the absence of a power supply. Therefore, non-volatile memory devices may be used to store data which needs to be stored regardless of power on/off conditions. Examples of the non-volatile memory devices include Read Only Memory (ROM), Mask ROM (MROM), Programmable ROM (PROM), Erasable Programmable ROM (EPROM), Electrically Erasable and Programmable ROM (EEPROM), flash memory, Phase-change Random Access Memory (PRAM), Magnetic RAM (MRAM), Resistive RAM (RRAM), and Ferroelectric RAM (FRAM). Flash memories may be classified into NOR-type memories and NAND-type memories.

### SUMMARY

Various embodiments of the present disclosure provide a memory system capable of performing wear leveling on the basis of an erase count of each of a plurality of memory blocks included in a super block, and an operating method thereof.

According to an embodiment, a memory system may include a memory device including a plurality of semiconductor memories each including a plurality of memory blocks; and a controller configuring a plurality of super blocks by grouping the plurality of memory blocks and controlling overall operations of each of the plurality of super blocks, wherein the controller performs wear leveling on the basis of first erase counts, one for each of the plurality of super blocks, and wherein the controller performs wear leveling on the basis of second erase counts, one for each of memory blocks in a super block in which a memory block becomes a bad block, among the plurality of super blocks.

According to an embodiment, memory system may include a plurality of semiconductor memories; and a controller coupled to the plurality of semiconductor memories, wherein the controller comprises a super block management module configuring a plurality of memory blocks included in the plurality of semiconductor memories as a plurality of super blocks, and a wear leveling management module performing wear leveling on the basis of first erase counts, one for each of the plurality of super blocks, and performing the wear leveling on the basis of second erase counts, one for each of memory blocks in a target super block in which a memory block becomes a bad block, among the plurality of super blocks.

According to an embodiment, method of operating a memory system may include grouping a plurality of memory blocks in a plurality of semiconductor memories into a plurality of super blocks; counting a number of erases performed on each of the plurality of super blocks to generate first erase counts, one for each of the plurality of super blocks, and performing wear leveling on the plurality of semiconductor memories on the basis of the first erase counts; changing a first erase count of a target super block in which a memory block becomes a bad block, among the plurality of super blocks, to second erase counts, one for each of the memory blocks in the target super blocks; and performing the wear leveling on the target super block on the basis of the second erase counts.

According to an embodiment, a method of operating a memory system may include grouping a plurality of memory blocks in a plurality of semiconductor memories into a plurality of super blocks; obtaining first erase counts by counting a number of erases performed on each of the super blocks; changing a first erase count of a target super block in which a memory block becomes a bad block, among the plurality of super blocks, to second erase counts, one for each of the memory blocks in the target super block; and performing a garbage collection operation by selecting a memory block with a smallest second erase count, among memory blocks in the target super block, as a target memory block.

According to an embodiment, memory system may include a memory device including a plurality of memory blocks; and a controller suitable for generating a plurality of super blocks by grouping the plurality of memory blocks and controlling the memory device based on the plurality of super blocks, wherein the controller: counts numbers of erases for the plurality of super blocks respectively to generate erase counts; determines whether a memory block in a particular super block, among the plurality of super blocks, has become bad (bad block); replaces the bad block with a replacement block from among the plurality of memory blocks, when it is determined that the bad block exists in the particular super block; performs wear leveling on the plurality of memory blocks based on current and previous erase counts of the particular super block, the previous erase count corresponding to an erase count of the particular super block when the bad block was replaced.

### BRIEF DESCRIPTION OF THE DRAWINGS

FIG. 1 is a block diagram illustrating a memory system according to an embodiment of the present disclosure;

FIG. 2 is a block diagram illustrating a configuration of a controller, such as that of FIG. 1;

FIG. 3 is a diagram illustrating a semiconductor memory, such as that shown in FIG. 1;

FIG. 4 is a diagram illustrating a memory block, such as that of FIG. 3;

FIG. 5 is a diagram illustrating an embodiment of a three-dimensionally structured memory block;

FIG. 6 is a diagram illustrating another embodiment of a three-dimensionally structured memory block;

FIG. 7 is a diagram illustrating a configuration of memory blocks and super blocks included in semiconductor memories;

FIG. 8 is a flowchart illustrating a method of operating a memory system according to an embodiment of the present disclosure;

FIG. 9 is a diagram illustrating a method of setting an erase count when a bad block is replaced according to an embodiment of the present disclosure;

FIG. 10 is a flowchart illustrating a method of operating a memory system according to an embodiment of the present disclosure;

FIG. 11 is a diagram illustrating a method of setting an erase count when a bad block is replaced according to an embodiment of the present disclosure;

FIG. 12 is a diagram illustrating a garbage collection operation performed based on an erase count;

FIG. 13 is a diagram illustrating a memory system according to an embodiment of the present disclosure;

FIG. 14 is a diagram illustrating a memory system according to an embodiment of the present disclosure;

FIG. 15 is a diagram illustrating a memory system according to an embodiment of the present disclosure; and

FIG. 16 is a diagram illustrating a memory system according to an embodiment of the present disclosure.

### DETAILED DESCRIPTION

Specific structural and functional detail is provided herein for the purpose of describing and illustrating embodiments of the invention. The invention, however, is not limited to the specific details presented. Various modifications including changes and substitutions may be made to any of the disclosed embodiments as those skilled in the art will understand from the present disclosure. Thus, the present invention is intended to embrace all such modifications that fall within the scope of the claims.

While terms such as “first” and “second” may be used to identify various components, such components are not limited by the above terms. The above terms are used to distinguish one component from the other component that otherwise have the same or similar names. For example, a first component in one instance may be referred to as a second component in another instance, or vice versa, without departing from the spirit and scope of the present invention.

It will be understood that when an element is referred to as being “connected” or “coupled” to another element, it can be directly connected or coupled to the other element or one or more intervening elements may also be present. In contrast, when an element is referred to as being “directly connected” or “directly coupled” to another element, no intervening elements are present. Other expressions describing relationships between components such as “˜ between,” “immediately ˜ between” or “adjacent to ˜” and “directly adjacent to ˜” may be construed similarly.

The terms used in the present application are merely used to describe particular embodiments, and are not intended to limit the present disclosure. Singular forms in the present disclosure are intended to include the plural forms as well, unless the context clearly indicates otherwise. In the present specification, it should be understood that terms “include” or “have” indicate that a feature, a number, a step, an operation, a component, a part or combination thereof is present, but do not exclude the possibility that one or more other features, numbers, steps, operations, components, parts or combinations thereof are present or added.

So far as not being differently defined, all terms used herein including technical or scientific terminologies have meanings that are commonly understood by those skilled in the art to which the present disclosure pertains. The terms defined in generally used dictionaries should be construed as having the same meanings as would be construed in the context of the related art, and unless clearly defined otherwise in this specification, should not be construed as having idealistic or overly formal meanings.

In some embodiments, well-known processes, device structures, and technologies are not described in detail to avoid ambiguousness of the present invention. This intends to avoid obscuring aspects of the present invention.

Various embodiments of the present disclosure are described in detail below with reference to the accompanying drawings in order for those skilled in the art to be able to readily implement the present invention.

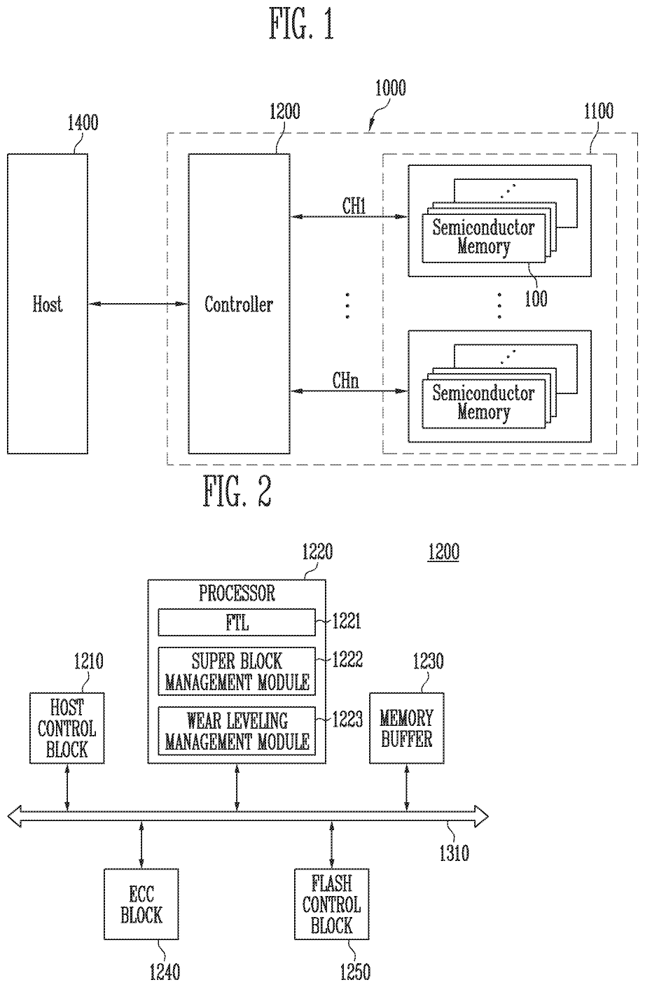

FIG. 1 is a block diagram illustrating a memory system 1000 according to an embodiment of the present disclosure.

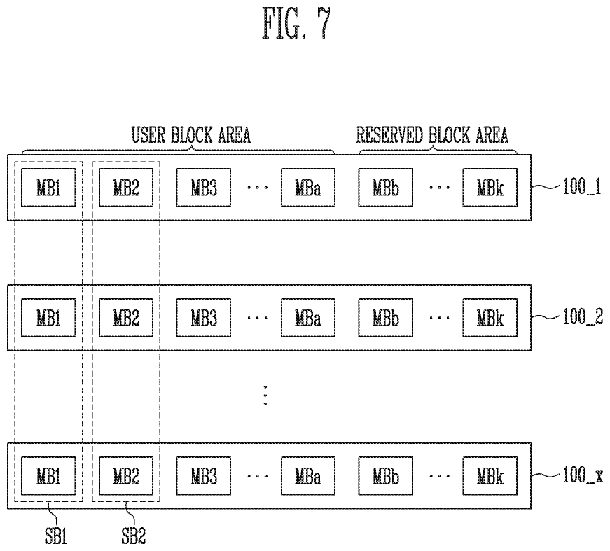

Referring to FIG. 1, the memory system 1000 may include a memory device 1100 and a controller 1200. The memory device 1100 may include a plurality of semiconductor memories 100. The plurality of semiconductor memories 100 may be divided into a plurality of groups. In addition, the memory system 1000 may configure a plurality of super blocks by grouping a plurality of memory blocks included in the plurality of semiconductor memories 100 into a plurality of groups. The above-described super blocks will be described below with reference to FIG. 7.

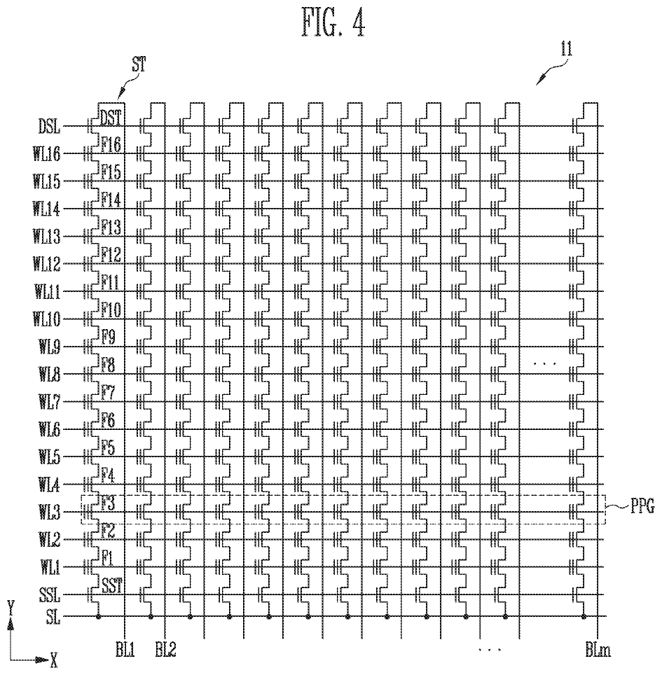

By way of example, FIG. 1 illustrates that first to nth groups of semiconductor memories communicate with the controller 1200 through first to nth channels CH1 to CHn, respectively. Any suitable number of groups and channels may be used. Each of the semiconductor memories 100 will be described below with reference to FIG. 3.

The semiconductor memories in a particular group may be configured to communicate with the controller 1200 through a single common channel. The controller 1200 may be configured to control the plurality of semiconductor memories 100 of the memory device 1100 through the plurality of channels CH1 to CHn.

The controller 1200 may be coupled between a host 1400 and the memory device 1100. The controller 1200 may be configured to access the memory device 1100 in response to a request from the host 1400. For example, the controller 1200 may control read, write, erase, and background operations of the memory device 1100 in response to the request received from the host 1400. The controller 1200 may be configured to provide an interface between the memory device 1100 and the host 1400. The controller 1200 may run firmware for controlling the memory device 1100. In addition, the controller 1200 may perform wear leveling on the basis of an erase number of at least one super block in the memory device 1100, i.e., an erase count in units of super blocks.

Wear leveling is a technique for prolonging the life of a memory device to facilitate evenly using all memory blocks included in the memory device 1100. The controller 1200 may perform a write operation by preferentially selecting a super block with a lowest erase number, among the plurality of super blocks, when receiving a write request from the host 1400. Some of the memory blocks included in a single super block may have the same erase number. In addition, when a block among the plurality of memory blocks in the super block becomes bad, the controller 1200 may reconfigure the super block by replacing the bad block with a reserved block and perform wear leveling on the basis of the erase number of each of the memory blocks of the super block including the reserved block. For example, the controller 1200 may perform a write operation by preferentially selecting memory blocks with smaller erase numbers, among the plurality of memory blocks included in the super block, when receiving a write request from the host 1400. In addition, during a garbage collection operation performed by securing a free block by copying data stored in a memory block to another memory block when the number of free blocks, i.e., blocks into which no data has been written, among the memory blocks in the memory device 1100, is low, the controller 1200 may select a memory block to be subject to the garbage collection operation on the basis of the erase number of the memory block.

The above-described memory system 1000 may further include a buffer memory.

The host 1400 may control the memory system 1000. The host 1400 may include any of a variety of portable electronic devices, such as PDAs, PMPs, MP3 players, cameras, camcorders, or cellular phones. The host 1400 may request a write operation, a read operation, and an erase operation of the memory system 1000 through a command.

The controller 1200 and the memory device 1100 may be integrated into one semiconductor device. According to an embodiment, the controller 1200 and the memory device 1100 may be integrated into a single semiconductor device to form a memory card, such as a personal computer memory card international association (PCMCIA), a compact flash card (CF), a smart media card (e.g., SM or SMC), a memory stick multimedia card (e.g., MMC, RS-MMC, or MMCmicro), a secure digital (SD) card (e.g., SD, miniSD, microSD, or SDHC), or a universal flash storage (UFS).

The controller 1200 and the memory device 1100 may be integrated into a single semiconductor device to form a solid state drive (SSD). The SSD may include a storage device for storing data in a semiconductor memory. When the memory system 1000 is used as the SSD, an operation speed of the host 1400 coupled to the memory system 1000 may be significantly improved.

In another example, the memory system 1000 may be provided as one of various elements of an electronic device such as a computer, a ultra-mobile PC (UMPC), a workstation, a net-book, a personal digital assistants (PDA), a portable computer, a web tablet, a wireless phone, a mobile phone, a smart phone, an e-book, a portable multimedia player (PMP), a game console, a navigation device, a black box, a digital camera, a 3-dimensional television, a digital audio recorder, a digital audio player, a digital picture player, a digital picture recorder, a digital video recorder, a device capable of transmitting/receiving information in an wireless environment, one of various devices for forming a home network, one of various electronic devices for forming a computer network, one of various electronic devices for forming a telematics network, an RFID device, or one of various elements for forming a computing system, or the like.

In an embodiment, the memory device 1100 or the memory system 1000 may be mounted in packages in various forms. For example, the memory device 1100 or the memory system 1000 may be embedded in packages, such as a package on package (PoP), ball grid arrays (BGAs), chip scale packages (CSPs), a plastic leaded chip carrier (PLCC), a plastic dual in line package (PDIP), a die in waffle pack, a die in wafer form, a chip on board (CoB), a ceramic dual in line package (CERDIP), a plastic metric quad flat pack (MQFP), a thin quad flatpack (TQFP), a small outline (SOIC), a shrink small outline package (SSOP), a thin small outline (TSOP), a thin quad flatpack (TQFP), a system in package (SiP), a multichip package (MCP), a wafer-level fabricated package (WFP), a wafer-level processed stack package (WSP), or the like.

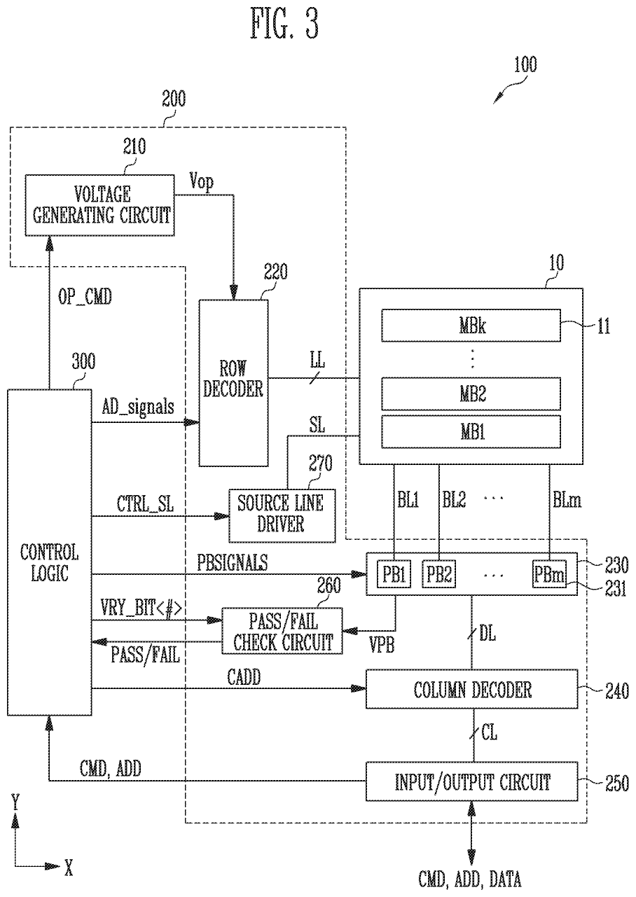

FIG. 2 is a diagram illustrating the controller 1200 shown in FIG. 1.

Referring to FIG. 2, the controller 1200 may include a host control block 1210, a processor 1220, a memory buffer 1230, an error correction code (ECC) block 1240, a flash control block 1250, and a bus 1310.

The bus 1310 may provide a channel between components of the controller 1200.

The host control block 1210 may control data transfer between the host 1400 of FIG. 1 and the memory buffer 1230. For example, the host control block 210 may buffer data input from the host 1400 to the memory buffer 1230. In another example, the host control block 1210 may control outputting the data buffered to the memory buffer 1230 to the host 1400. The host control block 1210 may include a host interface.

The processor 1220 may control the overall operation of the controller 1200 and perform a logical operation. The processor 1220 may communicate with the host 1400 through the host control block 1210 and may also communicate with the memory device 1100 of FIG. 1 through the flash control block 1250. In addition, the processor 1220 may control the memory buffer 1230. The processor 1220 may control the operations of the memory system 1000 by using the memory buffer 1230 as an operation memory, a cache memory, or a buffer memory.

The processor 1220 may include a flash translation layer (FTL) 1221, a super block management module 1222, and a wear leveling management module 1223.

The FTL 1221 may drive firmware stored in the memory buffer 1230. In addition, the FTL 1221 may map a physical address corresponding to a logical address input from the host 1400 of FIG. 1 during a data write operation, in particular, such that data received from the host 1400 during the data write operation may be programmed into at least one of the super blocks included in the memory device 1100. In addition, the FTL 1221 may check the physical address mapped to the logical address input from the host 1400 during a data read operation.

The super block management module 1222 may divide the memory blocks of the plurality of semiconductor memories 100 included in the memory device 1100 into the plurality of super blocks. For example, the super block management module 1222 may configure memory blocks from different semiconductor memories 100 as a single super block. In addition, when a bad block occurs among a plurality of memory blocks included in the single super block, the super block management module 1222 may reconfigure the super block by replacing the bad block with a reserved block.

The wear leveling management module 1223 may manage an erase number in units of super blocks and select a super block corresponding to a write request received from the host 1400 on the basis of the erase number of each of the super blocks. The wear leveling management module 1223 may preferentially select and allocate a super block with the smallest erase number in response to the write request. In addition, when a bad block occurs among the memory blocks in the super block and is replaced by a reserved block, the wear leveling management module 1223 may perform wear leveling by managing the erase number of each of the memory blocks in the super block. For example, when the wear leveling management module 1223 receives the write request from the host 1400, the wear leveling management module 1223 may preferentially select memory blocks with smaller erase numbers, among the plurality of memory blocks in the super block. Information about an erase number in units of super blocks and information about an erase count in units of memory blocks, each of which is managed by the wear leveling management module 1223, may be stored in the memory device 1100.

The memory buffer 1230 may serve as an operation memory, a cache memory, or a buffer memory of the processor 1220. The memory buffer 1230 may store codes and commands executed by the processor 1220. The memory buffer 1230 may store data that is processed by the processor 1220. The memory buffer 1230 may include a static RAM (SRAM) or a dynamic RAM (DRAM). The memory buffer 1230 may store a command queue which is generated by the processor 1220.

The ECC block 1240 may perform error correction. The ECC block 1240 may perform ECC encoding based on data to be written to the memory device 1100 of FIG. 1 through the flash control block 1250. The ECC-encoded data may be transferred to the memory device 1100 through the flash control block 1250. The ECC block 1240 may perform ECC decoding on data received from the memory device 1100 through the flash control block 1250. For example, the ECC block 1240 may be one of the components of the flash control block 1250.

The flash control block 1250 may generate and output an internal command for controlling the memory device 1100 in response to the command queue generated by the processor 1220. The flash control block 1250 may control transferring the data buffered to the memory buffer 1230 during the data write operation to the memory device 1100 so as to program the data. In another example, the flash control block 1250 may control buffering the data, which is read and output from the memory device 1100 in response to the command queue during the data read operation, to the memory buffer 1230. The host control block 1250 may include a flash interface.

FIG. 3 is a diagram illustrating the semiconductor memory 100 of FIG. 1.

Referring to FIG. 3, the semiconductor memory 100 may include a memory cell array 10 in which data is stored. The semiconductor memory 100 may include a peripheral circuit 200 configured to perform a program operation for storing data in the memory cell array 10, a read operation for outputting the stored data, and an erase operation for erasing the stored data. The semiconductor memory 100 may include control logic 300 for controlling the peripheral circuit 200 in response to control of the controller 1200 of FIG. 1.

The memory cell array 10 may include a plurality of memory blocks (MB1 to MBk) 11, where k is a positive integer. Each of the memory blocks (MB1 to MBk) 11 may be coupled to local lines LL and bit lines BL1 to BLm, where m is a positive integer. For example, the local lines LL may include a first select line, a second select line, and a plurality of word lines arranged between the first and second select lines. In addition, the local lines LL may include a plurality of dummy lines arranged between the first select line and the word lines and between the second select line and the word lines. The first select line may be a source select line and the second select line may be a drain select line. The local lines LL may include the word lines, the drain and source select lines, and source lines SL. The local lines LL may further include dummy lines. The local lines LL may further include pipe lines. The local lines LL may be coupled to the memory blocks (MB1 to MBk) 11, respectively, and the bit lines BL1 to BLm may be commonly coupled to the memory blocks (MB1 to MBk) 11. The memory blocks (MB1 to MBk) 11 may have a two-dimensional (2D) or three-dimensional (3D) structure. In the 2D memory blocks 11, the memory cells may be arranged in parallel with respect to a substrate. In the 3D memory blocks 11, the memory cells may be stacked in a vertical direction with respect to the substrate.

The peripheral circuit 200 may be configured to perform program, read and erase operations on the selected memory block 11 in response to control of the control logic 300. The peripheral circuit 200 may include a voltage generating circuit 210, a row decoder 220, a page buffer group 230, a column decoder 240, an input and output (input/output) circuit 250, a pass and fail (pass/fail) check circuit 260, and a source line driver 270.

The voltage generating circuit 210 may generate various operating voltages Vop applied to perform program, read and erase operations in response to an operation signal OP_CMD. In addition, the voltage generating circuit 210 may selectively discharge the local lines LL in response to the operation signal OP_CMD. For example, the voltage generating circuit 210 may generate a program voltage, a verify voltage, a pass voltage, and a selection transistor operating voltage in response to control of the control logic 300.

The row decoder 220 may transfer the operating voltages Vop to the local lines LL coupled to the selected memory block 11 in response to row decoder control signals AD_signals. For example, the row decoder 220 may selectively apply operating voltages (e.g., a program voltage, a verify voltage, and a pass voltage) generated by the voltage generating circuit 210 to the word lines of the local lines LL in response to the row recorder control signals AD_signals.

The row decoder 220 may apply the program voltage generated by the voltage generating circuit 210 to a selected word line, among the local lines LL, and may apply the pass voltage generated by the voltage generating circuit 210 to unselected word lines in response to the row decoder control signals AD_signals during a program voltage applying operation. In addition, the row decoder 220 may apply the read voltage generated by the voltage generating circuit 210 to the selected word line, among the local lines LL, and may apply the pass voltage generated by the voltage generating circuit 210 to the unselected word lines in response to the row decoder control signals AD_signals during a read operation.

The page buffer group 230 may include a plurality of page buffers (PB1 to PBm) 231 coupled to the bit lines BL1 to BLm. The page buffers (PB1 to PBm) 231 may operate in response to page buffer control signals PBSIGNALS. For example, the page buffers (PB1 to PBn) 231 may temporarily store data to be programmed during a program operation, or may sense voltages or currents in the bit lines BL1 to BLm during a read or verify operation.

The column decoder 240 may transfer data between the input/output circuit 250 and the page buffer group 230 in response to a column address CADD. For example, the column decoder 240 may exchange data with the page buffers 231 through data lines DL, or with the input/output circuit 250 through column lines CL.

The input/output circuit 250 may transfer an internal command CMD and an address ADD from the controller 1200 of FIG. 1 to the control logic 300, or may exchange data DATA with the column decoder 240.

The pass/fail check circuit 260 may generate a reference current in response to an allowable bit VRY_BIT<#>. The pass/fail check circuit 260 may compare a sensing voltage VPB received from the page buffer group 230 with a reference voltage generated by the reference current to output a pass signal PASS or a fail signal FAIL during a read operation or a verify operation.

The source line driver 270 may be coupled to the memory cells included in the memory cell array 10 through a source line SL to control a voltage applied to the source line SL. The source line driver 270 may receive a source line control signal CTRL_SL from the control logic 300 and control a source line voltage applied to the source line SL on the basis of the source line control signal CTRL_SL.

The control logic 300 may control the peripheral circuit 200 by outputting the operation signal OP_CMD, the row decoder control signals AD_signals, the page buffer control signals PBSIGNALS and the allowable bit VRY_BIT<#> in response to the internal command CMD and the address ADD. In addition, the control logic 300 may determine whether the verify operation passes or fails in response to the pass or fail signal PASS or FAIL.

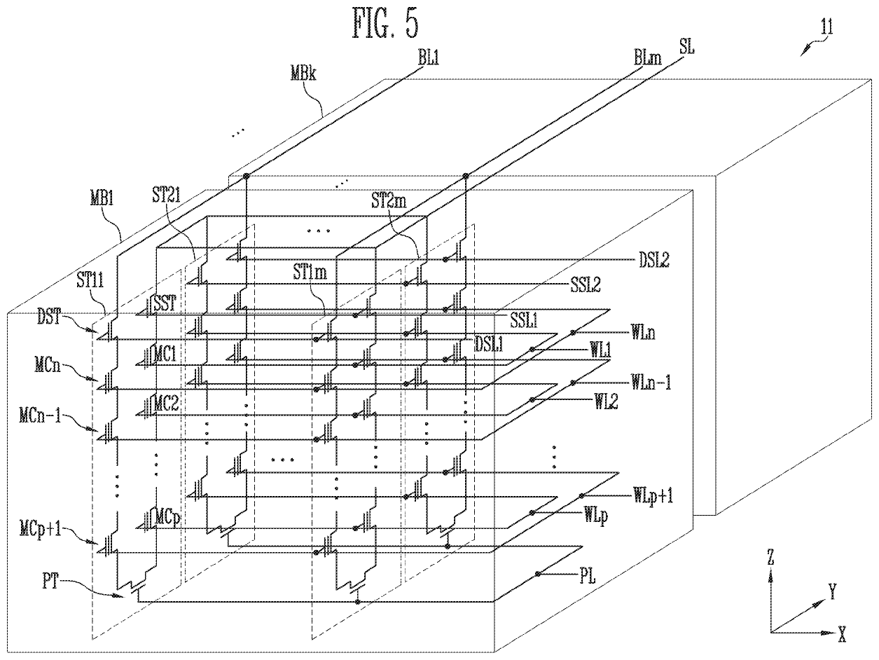

FIG. 4 is a diagram illustrating the memory block 11 shown in FIG. 3.

Referring to FIG. 4, the memory block 11 may be coupled to the plurality of word lines arranged in parallel with the first select line and the second select line. The first select line may be a source select line SSL and the second select line may be a drain select line DSL. More specifically, the memory block 11 may include a plurality of strings ST coupled between the bit lines BL1 to BLm and the source line SL. The bit lines BL1 to BLm may be coupled to the strings ST, respectively, and the source line SL may be coupled in common to the strings ST. Since the strings ST may have the same configuration, the string ST coupled to the first bit line BL1 will be described in detail as an example.

Each of the strings ST may include a source select transistor SST, a plurality of memory cells F1 to F16, and a drain select transistor DST which are coupled in series between the source line SL and the first bit line BL1. A single string ST may include at least one source select transistor SST, at least one drain select transistor DST, and more than the 16 (F1 to F16) memory cells shown in FIG. 4.

A source of the source select transistor SST may be coupled to the source line SL, and a drain of the drain select transistor DST may be coupled to the first bit line BL1. The memory cells F1 to F16 may be coupled in series between the source select transistor SST and the drain select transistor DST. Gates of the source select transistors SST included in different strings ST may be coupled to the source select line SSL, gates of the drain select transistors DST may be coupled to the drain select line DSL, and gates of the memory cells F1 to F16 may be coupled to a plurality of word lines WL1 to WL16. A group of memory cells coupled to the same word line, among memory cells included in different strings ST, may be referred to as a physical page PPG. Therefore, the memory block 11 may include as many physical pages PPG as the number of word lines WL1 to WL16.

A single memory cell may store one bit of data. This memory cell is generally called a single level cell (SLC). A single physical page PPG may store data corresponding to a single logical page LPG. Data corresponding to the single logical page LPG may include as many data bits as the number of cells included in the single physical page PPG. In addition, a single memory cell may store two or more bits of data. This cell is typically referred to as a “multi-level cell (MLC)”. The single physical page PPG may store data corresponding to two or more logical pages LPG.

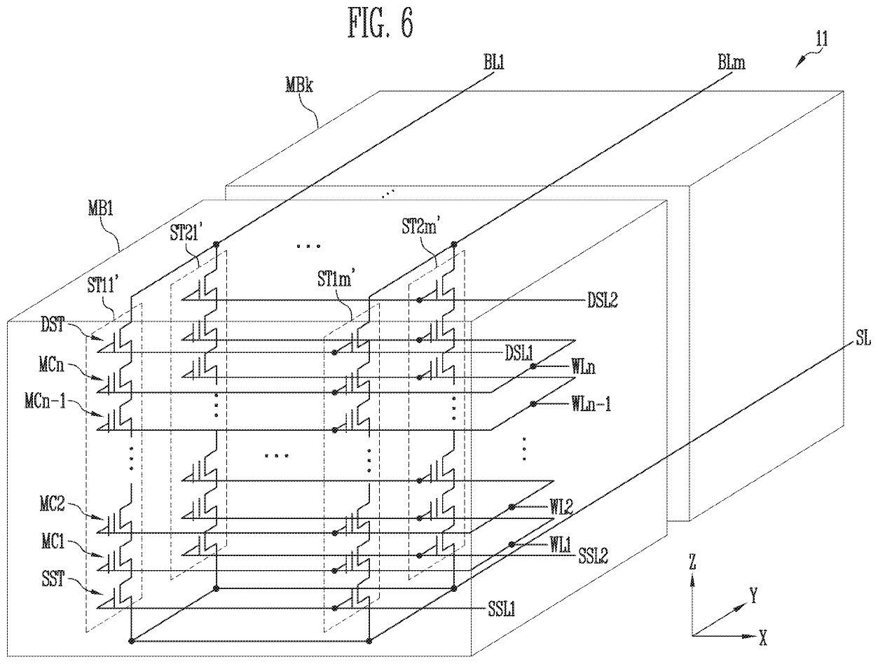

FIG. 5 is a diagram illustrating an embodiment of a three-dimensionally structured memory block.

Referring to FIG. 5, the memory cell array 10 of FIG. 3 may include the plurality of memory blocks (MB1 to MBk) 11. The memory block 11 may include a plurality of strings ST11 to ST1m and ST21 to ST2m. According to an embodiment, each of the plurality of strings ST11 to ST1m and ST21 to ST2m may have a ‘U’ shape. In the first memory block MB1, ‘m’ strings may be arranged in a row direction (e.g., X direction). By way of example and for clarity, FIG. 5 illustrates two strings arranged in a column direction (e.g., Y direction). However, three or more strings may be arranged in the column direction (e.g., Y direction).

Each of the plurality of strings ST11 to ST1m and ST21 to ST2m may include at least one source select transistor SST, first to nth memory cells MC1 to MCn, a pipe transistor PT, and at least one drain select transistor DST.

The source and drain select transistors SST and DST and the memory cells MC1 to MCn may have similar structures to each other. For example, each of the source and drain select transistors SST and DST and the memory cells MC1 to MCn may include a channel layer, a tunnel insulating layer, a charge trap layer, and a blocking insulating layer. For example, a pillar for providing a channel layer may be provided in each string. For example, a pillar for providing at least one of the channel layer, the tunnel insulating layer, the charge trap layer and the blocking insulating layer may be provided in each string.

The source select transistor SST of each string may be coupled between the source line SL and the memory cells MC1 to MCp.

In an embodiment, source select transistors of strings arranged in the same row may be coupled to a source select line extending in the row direction, and source select transistors of strings arranged in different rows may be coupled to different source select lines. As shown in FIG. 5, the source select transistors of the strings ST11 to ST1m in the first row may be coupled to the first source select line SSL1. The source select transistors of the strings ST21 to ST2m arranged in the second row may be coupled to the second source select line SSL2.

According to another embodiment, the source select transistors of the strings ST11 to ST1m and ST21 to ST2m may be commonly coupled to one source select line.

The first to nth memory cells MC1 to MCn of each string may be coupled between the source select transistor SST and the drain select transistor DST.

The first to nth memory cells MC1 to MCn may be divided into first to pth memory cells MC1 to MCp and (p+1)th to nth memory cells MCp+1 to MCn. The first to pth memory cells MC1 to MCp may be sequentially arranged in a vertical direction (e.g., Z direction) and be coupled in series between the source select transistor SST and the pipe transistor PT. The (p+1)th to nth memory cells MCp+1 to MCn may be sequentially arranged in the vertical direction (e.g., Z direction) and be coupled in series between the pipe transistor PT and the drain select transistor DST. The first to pth memory cells MC1 to MCp and the (p+1)th to nth memory cells MCp+1 to MCn may be coupled to each other through the pipe transistor PT. The gates of the first to nth memory cells MC1 to MCn of each string may be coupled to the first to nth word lines WL1 to WLn, respectively.

According to an embodiment, at least one of the first to nth memory cells MC1 to MCn may serve as a dummy memory cell. When the dummy memory cell is provided, a voltage or current of the corresponding string may be stably controlled. A gate of the pipe transistor PT of each string may be coupled to a pipe line PL.

The drain select transistor DST of each string may be coupled between the corresponding bit line and the memory cells MCp+1 to MCn. Strings arranged in the row direction may be coupled to a drain select line extending in the row direction. Drain select transistors of the strings ST11 to ST1m in the first row may be coupled to the first drain select line DSL1. Drain select transistors of the strings ST21 to ST2m in the second row may be coupled to the second drain select line DSL2.

Strings arranged in the column direction may be coupled to bit lines extending in the column direction. As shown in FIG. 5, the strings ST11 and ST21 in the first column may be coupled to the first bit line BL1. The strings ST1m and ST2m in the mth column may be coupled to the mth bit line BLm.

Memory cells coupled to the same word line, among the strings arranged in the row direction, may form a single page. For example, memory cells coupled to the first word line WL1, among the strings ST11 to ST1m in the first row, may constitute one page. Among the strings ST21 to ST2m in the second row, memory cells coupled to the first word line WL1 may constitute one additional page. When one of the drain select lines DSL1 and DSL2 is selected, strings arranged in one row direction may be selected. One page may be selected from the selected strings by selecting one of the word lines WL1 to WLn.

FIG. 6 is a diagram illustrating an embodiment of a three-dimensionally structured memory block.

Referring to FIG. 6, the memory cell array 10 of FIG. 3 may include the plurality of memory blocks (MB1 to MBk) 11. The memory block 11 may include a plurality of strings ST11′ to ST1m′ and ST21′ to ST2m′. Each of the plurality of strings ST11′ to ST1m′ and ST21′ to ST2m′ may extend in a vertical direction (e.g., Z direction). In the memory block 11, ‘m’ strings may be arranged in a row direction (e.g., X direction). Although FIG. 6 illustrates that two strings are arranged in a column direction (e.g., Y direction), this embodiment is given as an example; three or more strings may be arranged in the column direction (e.g., Y direction) in other embodiments.

Each of the plurality of strings ST11′ to ST1m′ and ST21′ to ST2m′ may include at least one source select transistor SST, first to nth memory cells MC1 to MCn, and at least one drain select transistor DST.

The source select transistor SST of each string may be coupled between the source line SL and the memory cells MC1 to MCn. Source select transistors of strings arranged in the same row may be coupled to the same source select line. The source selection transistors of the strings ST11′ to ST1m′ arranged in the first row may be coupled to a first source select line SSL1. The source select transistors of the strings ST21′ to ST2m′ arranged in the second row may be coupled to a second source select line SSL2. According to another embodiment, the source select transistors of the strings ST11′ to ST1m′ and ST21′ to ST2m′ may be commonly coupled to a single source select line.

The first to nth memory cells MC1 to MCn of each string may be coupled in series between the source select transistor SST and the drain select transistor DST. Gates of the first to nth memory cells MC1 to MCn may be coupled to the first to nth word lines WL1 to WLn, respectively.

According to an embodiment, at least one of the first to nth memory cells MC1 to MCn may serve as a dummy memory cell. When the dummy memory cell is provided, a voltage or current of the corresponding string may be stably controlled. As a result, the reliability of data stored in the memory block 11 may be improved.

The drain select transistor DST of each string may be coupled between the corresponding bit line and the memory cells MC1 to MCn. The drain select transistors DST of strings arranged in the row direction may be coupled to the drain select line extending in the row direction. The drain select transistors DST of strings CS11′ to CS1m′ in the first row may be coupled to a first drain select line DSL1. The drain selection transistors DST of strings CS21′ to CS2m′ in the second row may be coupled to a second drain select line DSL2.

FIG. 7 is a diagram illustrating a configuration of memory blocks and super blocks included in semiconductor memories 100_1 to 100_x.

Referring to FIG. 7, each of the plurality of semiconductor memories 100_1 to 100_x may include the plurality of memory blocks MB1 to MBk. The plurality of semiconductor memories 100_1 to 100_x may be the plurality of semiconductor memories 100 included in the memory device 1100 of FIG. 1. Each of the plurality of semiconductor memories 100_1 to 100_x may include memory blocks MB1 to MBa in a user block area, and memory blocks MBb to MBk in a reserved block area.

Each of a plurality of super blocks SB1 and SB2 may include at least one of the memory blocks MB1 to MBa in the user block area in each of the plurality of semiconductor memories 100_1 to 100_x. According to an embodiment of the present disclosure, the memory blocks MB1 of the plurality of semiconductor memories 100_1 to 100_x may form super block SB1, and the memory blocks MB2 of the plurality of semiconductor memories 100_1 to 100_x may form super block SB2. However, the present disclosure is not limited to this arrangement. The remaining memory blocks (for example, MB3 to MBa) which are not included in the super blocks SB1 and SB2, among the memory blocks MB1 to MBa in the user block area, may be free blocks. These free blocks may be included in a new super block when the new super block is configured later. In addition, some of the free blocks may be allocated to an over-provisioning area to improve the performance of the memory system.

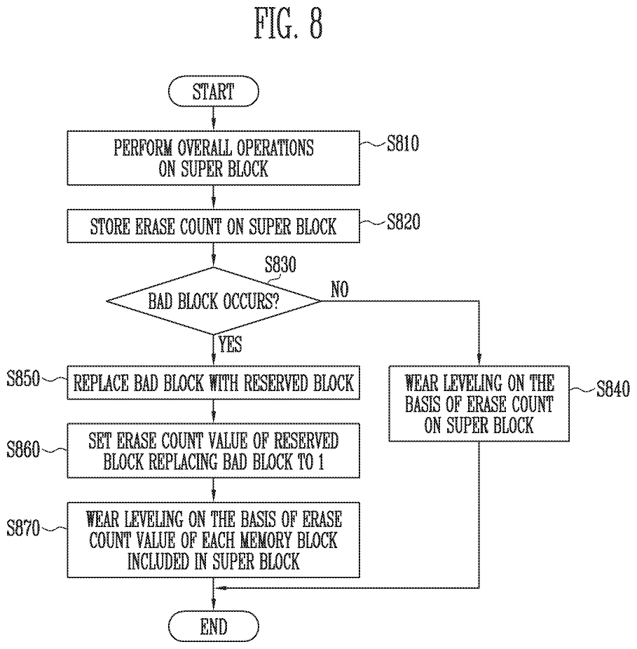

FIG. 8 is a flowchart illustrating a method of operating a memory system (e.g., the memory system 1000 of FIG. 1) according to an embodiment of the present disclosure.

The method of operating the memory system 1000 in FIG. 8 is described below with additional reference to FIGS. 1 to 7.

When the controller 1200 receives a request (e.g., a write request or a read request) from the host 1400, the controller 1200 may perform overall operations such as a program operation, a read operation, and an erase operation by selecting the super block SB1 or SB2 according to each request (S810). Also, the controller 1200 may preferentially select a super block with a smallest erase count, among the plurality of super blocks, to perform a write operation when the controller 1200 receives a new write request. In addition, when a super block on which a write operation is to be performed is not present, although the controller 1200 receives a new write request, the controller 1200 may perform the write operation by configuring a new super block including some free blocks, among the memory blocks MB1 to MBa in the user block area, and allocating the new super block in response to the new write request.

When the wear leveling management module 1223 of the processor 1220 performs the erase operation among the overall operations of the memory device 1100, the memory device 1100 may be controlled to generate an erase count by counting an erase number of the super block on which the erase operation is performed, and to store the generated erase count in an area of the corresponding super block (S820).

It may be determined whether there is a bad block during the overall operations on the above-described super blocks (S830). When it is determined that there is no bad block S830, No), as a result of the operations being successfully performed, the write operation may be performed by selecting one of the plurality of super blocks on the basis of the erase count of each of the super blocks when a new write request is received from the host 1400. In other words, by performing the write operation by preferentially selecting a super block with the smallest erase count, wear leveling may be performed to achieve even wear of all super blocks (S840).

When it is determined that there is bad block (S830, Yes), the super block management module 1222 may replace the memory block determined as the bad block by using a free block (e.g., MBb of FIG. 7) included in the reserved block area to thereby reconfigure the super block (S850).

When the super block is reconfigured by replacing the bad block of the super block with the free block in the reserved block area, the wear leveling management module 1223 may manage the erase count of each of the memory blocks included in the corresponding super block in units of memory blocks (or a physical block unit). The physical block unit may be a minimum erase unit of the semiconductor memory 100. The wear leveling management module 1223 may set an erase count of the replacement memory block in the reserved block area, among the memory blocks included in the corresponding super block, to ‘1’ (S860) since the replacement memory block is provided in an initial erase state. Then, the wear leveling management module 1223 may set an erase count of each of the remaining memory blocks to a value less than the erase count value of the corresponding super block.

Thereafter, when the corresponding super block is selected in response to a new write request received from the host 1400, the write operation may be performed by preferentially selecting some of the plurality of memory blocks on the basis of the erase count of each of the memory blocks included in the corresponding super block. In other words, by performing a write operation by preferentially selecting memory blocks with smaller erase counts, wear leveling may be performed to achieve even wear of the memory blocks included in the corresponding super block (S870).

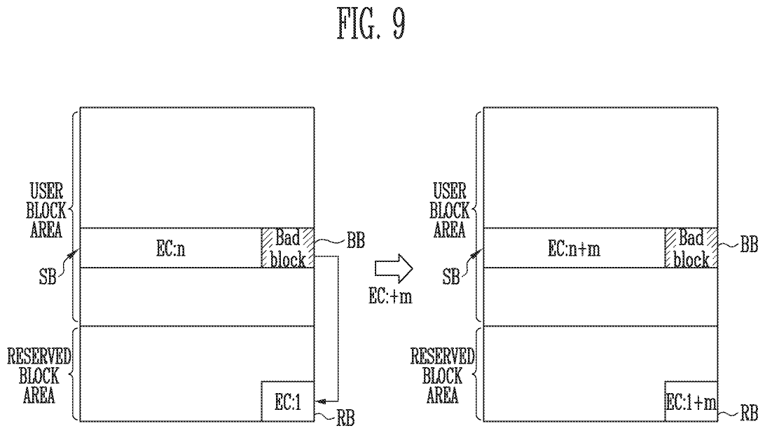

FIG. 9 is a diagram illustrating a method of setting an erase count when a bad block is replaced according to an embodiment of the present disclosure.

Referring to FIG. 9, an erase count EC value of the super block SB including some of the memory blocks included in the user block area may be counted as ‘n’ when an erase operation is performed n times. Subsequently, when at least one of the memory blocks included in the super block SB is determined as a bad block BB, the bad block BB may be replaced with a reserved block RB by selecting some of the memory blocks included in the reserved block area. The erase count EC of the reserved block RB may be set to 1.

Subsequently, when the erase operation is performed m times by repeatedly performing the overall operations of the corresponding super block SB, the erase count EC of each of the memory blocks included in the super block SB may be counted as ‘n+m’, and the erase count EC of the reserved block RB replacing the bad block BB of the super block SB may be counted as ‘1+m’.

As described above, according to an embodiment of FIGS. 8 and 9, wear leveling may be performed by counting the erase count in units of super blocks before the bad block occurs, and by counting the erase count in units of memory blocks when the bad block occurs and is replaced by the reserved block, so that even wear of the memory blocks included in the memory device 1100 may be maintained to extend the life of the memory system 1000.

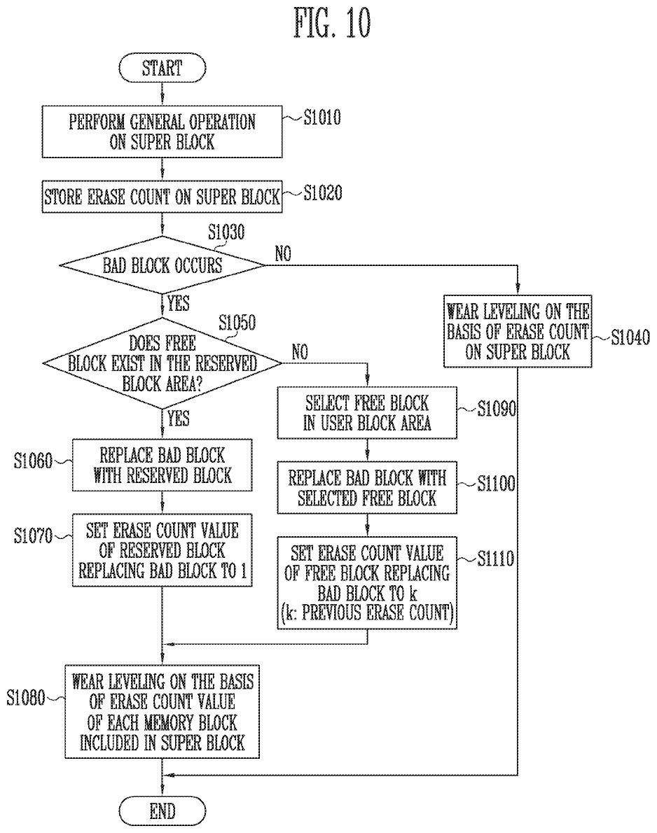

FIG. 10 is a flowchart illustrating a method of operating a memory system (e.g., the memory system 1000 of FIG. 1) according to an embodiment of the present disclosure.

The method of operating the memory system 1000 in FIG. 10 is described below with reference to FIGS. 1 to 7.

When the controller 1200 receives a request (e.g., a write request and a read request) from the host 1400, the controller 1200 may perform overall operations such as a program operation, a read operation, and an erase operation by selecting the super block SB1 or SB2 according to each request (S1010). Also, the controller 1200 may preferentially select a super block with a smallest erase count, among the plurality of super blocks, to perform a write operation when the controller 1200 receives a new write request. In addition, when a super block on which the write operation is to be performed is not present, although the controller 1200 receives the new write request, the controller 1200 may perform the write operation by configuring a new super block including some free blocks among the memory blocks MB1 to MBa in the user block area of the plurality of memory blocks in the semiconductor memory 100, and allocating the new super block in response to the new write request.

When the wear leveling management module 1223 of the processor 1220 performs an erase operation, among the overall operations of the memory device 1100, the memory device 1100 may be controlled to generate an erase count by counting an erase number of the super block on which the erase operation is performed, and to store the generated erase count in an area of the corresponding super block (S1020).

It may be determined whether a bad block occurs during the overall operations on the above-described super blocks (S1030). When it is determined that the bad block does not occur since the overall operations are successfully performed (S1030, No), a write operation may be performed by selecting one of the plurality of super blocks on the basis of the erase count of each of the super blocks when a new write request is received from the host 1400. In other words, by performing the write operation by preferentially selecting a super block with the smallest erase count, wear leveling may be performed to achieve even wear of all super blocks (S1040).

When it is determined that the bad block occurs (S1030, YES), the super block management module 1222 may determine whether a free block exists in the reserved block area (S1050).

As a result of the determination (S1050), when it is determined that the free block exists in the reserved block area (S1050, YES), the super block management module 1222 may replace a memory block determined as the bad block by using the free block (e.g., MBb of FIG. 7) in the reserved block area to thereby reconfigure the super block (S1060).

When the super block is reconfigured by replacing the bad block of the super block with the free block in the reserved block area, the wear leveling management module 1223 may manage the erase count of each of the memory blocks in the corresponding super block in units of blocks. The block unit may be a minimum erase unit of the semiconductor memory 100. The wear leveling management module 1223 may set the erase count of the replacement memory block in the reserved block area to ‘1’ (S1070) since the replacement memory block is provided in an initial erase state. Then, the wear leveling management module 1223 may set erase counts of the remaining memory blocks to an erase count value of the corresponding super block.

Subsequently, when the corresponding super block is selected in response to a new write request received from the host 1400, a write operation may be performed by preferentially selecting some of the plurality of memory blocks on the basis of the erase count of each of the memory blocks included in the corresponding super block. In other words, by performing a write operation by preferentially selecting memory blocks with smaller erase counts, wear leveling may be performed to achieve even wear of the memory blocks included in the corresponding super block (S1080).

As a result of the determination (S1050), when it is determined that the free block does not exist in the reserved block area (S1050, NO), the super block management module 1222 may select an extra free block not included in another super block, among the memory blocks in the user block area (S1090). The above-described free block may be a free block allocated to an over-provisioning area.

The super block management module 1222 may replace the bad block with the free block selected from the over-provisioning area (S1100). An erase count of the free block may be set to an erase count value of k (where k is a previous erase count) before being selected (S1110). Subsequently, when the corresponding super block is selected in response to a new write request received from the host 1400, a write operation may be performed by preferentially selecting some of the plurality of memory blocks on the basis of the erase count of each of the memory blocks included in the corresponding super block. In other words, by performing the write operation by preferentially selecting memory blocks with smaller erase counts, wear leveling may be performed to achieve even wear of the memory blocks included in the corresponding super block (S1080).

FIG. 11 is a diagram illustrating a method of setting an erase count when a bad block is replaced according to an embodiment of the present disclosure.

Referring to FIG. 11, the erase count EC value of the super block SB, including some of the memory blocks in the user block area, may be counted as ‘n’ when an erase operation is performed n times. When at least one of the memory blocks included in the super block SB is determined as the bad block BB, the bad block(s) BB may be replaced by selecting memory block(s) in the reserved block area. However, when all memory blocks in the reserved block area are used up, the bad block BB may be replaced by selecting the free block FB not included among the memory blocks in the user block area. The above-described free block may be allocated to the over-provisioning area. Since the free block FB may be used and removed during the overall operations before being selected, the erase count EC may be set to the erase count value of k, where k is the erase count value before the free block FB replaces the bad block.

Subsequently, when the erase operation is performed m times by repeatedly performing the overall operations of the corresponding super block SB, the erase count EC of each of the memory blocks included in the super block SB may be counted as ‘n+m’, and the erase count EC of the free block FB replacing the bad block BB of the super block SB may be counted as ‘k+m’.

As described above, according to an embodiment of FIGS. 10 and 11, when the reserved block for replacing the bad block does not exist, the bad block may be replaced using the free block in the user block area. In addition, when the bad block is replaced using the free block in the user block area, wear leveling may be performed by counting the erase count in units of memory blocks, so that even wear of the memory blocks in the memory device 1100 may be maintained to thereby improve the life of the memory system.

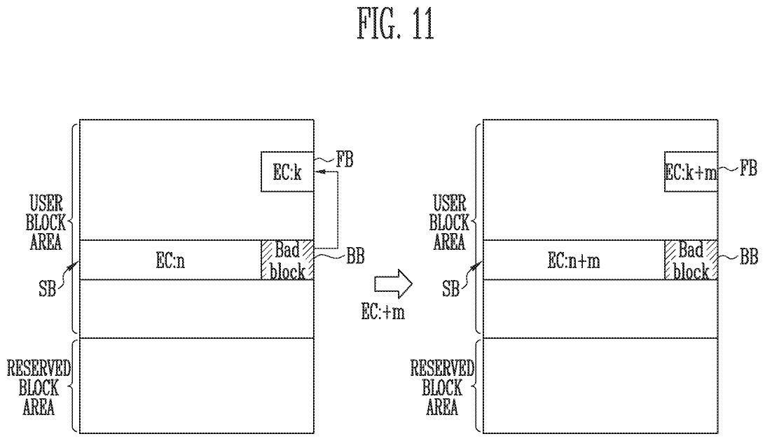

FIG. 12 is a diagram illustrating a garbage collection operation performed based on an erase count.

As shown in FIGS. 8 and 10, when the bad block occurs and is replaced by the reserved block or the free block in the user block area, the erase count of each of the memory blocks MB1, MB2, and MB3 included in the super blocks SB1 to SB3 in which the bad block occurs as shown in FIG. 12 may be managed in units of blocks.

By way of example, the plurality of memory blocks MB1 included in the super block SB1 may have the erase counts EC of x, x+1, x+2, and x−1, respectively. The memory blocks MB2 included in the super block SB2 may have the erase counts EC of y, y−1, y−2, and y, respectively. The memory blocks MB3 included in the super block SB3 may have the erase counts EC of z, z+1, z+1, and z+2, respectively.

When there are not enough free blocks among the memory blocks in the user block area, free blocks may be secured by performing a garbage collection operation. Memory blocks with smaller erase counts EC, among the memory blocks included in the super blocks SB1 to SB3, may be selected as target memory blocks on which the garbage collection operation is performed. For example, a garbage collection operation GC may be performed by selecting the memory block having the erase count of x−1, among the plurality of memory blocks MB1 in the super block SB1, the memory block having the erase count of y−2, among the plurality of memory blocks MB2 in the super block SB2, and the memory block having the erase count of z, among the plurality of memory blocks MB3 in the super block SB3, so that the selected memory blocks may be allocated as memory blocks MB4 in a new super block SB4. Therefore, the new super block SB4 may include the memory blocks with the smaller erase counts EC and be preferentially selected during a new write operation, so that the life of the memory system 1000 may be improved.

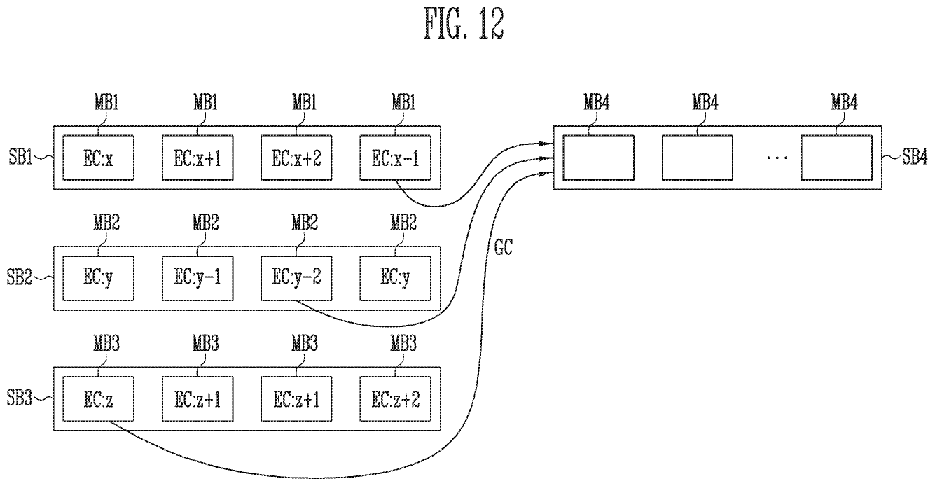

FIG. 13 is a diagram illustrating a memory system 30000 according to an embodiment of the present disclosure.

Referring to FIG. 13, the memory system 30000 may be embodied in a cellular phone, a smartphone, a tablet PC, a personal digital assistant (PDA), or a wireless communication device. The memory system 30000 may include the memory device 1100 and the controller 1200 controlling the operations of the memory device 1100. The controller 1200 may control a data access operation of the memory device 1100, e.g., a program operation, an erase operation or a read operation under the control of a processor 3100.

The controller 1200 may control data programmed into the memory device 1100 to be output through a display 3200 in response to control of the controller 1200.

The controller 1200 may form a super block using some of the plurality of memory blocks included in the memory device 1100.

A radio transceiver 3300 may exchange a radio signal through an antenna ANT. For example, the radio transceiver 3300 may convert the radio signal received through the antenna ANT into a signal which can be processed by the processor 3100. Therefore, the processor 3100 may process the signal output from the radio transceiver 3300 and transfer the processed signal to the controller 1200 or the display 3200. The controller 1200 may program the signal processed by the processor 3100 into the memory device 1100. In addition, the radio transceiver 3300 may convert a signal output from the processor 3100 into a radio signal and output the radio signal to an external device through the antenna ANT. A control signal for controlling the operations of the processor 3100 or data to be processed by the processor 3100 may be input by an input device 3400. The input device 3400 may include a pointing device, such as a touch pad and a computer mouse, a keypad, or a keyboard. The processor 3100 may control operations of the display 3200 so that the data output from the controller 1200, the data output from the wireless transceiver 3300, or the data output from the input device 3400 may be displayed on the display 3200.

According to an embodiment, the controller 1200 for controlling the operations of the memory device 1100 may be formed as a part of the processor 3100, or a separate chip from the processor 3100. In addition, the controller 1200 may be formed through an example of the controller 1200 shown in FIG. 2.

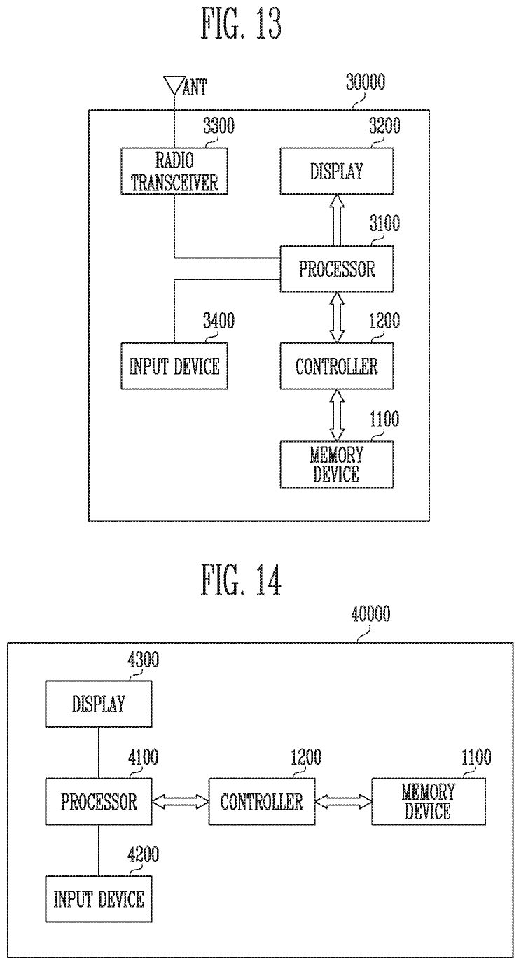

FIG. 14 is a diagram illustrating a memory system 40000 according to an embodiment of the present disclosure.

Referring to FIG. 14, the memory system 40000 may be provided as a personal computer (PC), a tablet, a net-book, an e-reader, a personal digital assistant (PDA), a portable multimedia player (PMP), an MP3 player, or an MP4 player.

The memory system 40000 may include the memory device 1100 and the controller 1200 controlling the data processing operations of the memory device 1100.

The controller 1200 may form a super block using some of the plurality of memory blocks included in the memory device 1100.

A processor 4100 may output data stored in the memory device 1100 through a display 4300 according to data input through an input device 4200. Examples of the input device 4200 include a pointing device, such as a touch pad or a computer mouse, a keypad, or a keyboard.

The processor 4100 may control the overall operations of the memory system 40000 and control the operations of the controller 1200. According to an embodiment, the controller 1200 for controlling the operations of the memory device 1100 may be formed as a part of the processor 4100, or a separate chip from the processor 4100. In addition, the controller 1200 may be formed through an example of the controller 1200 shown in FIG. 2.

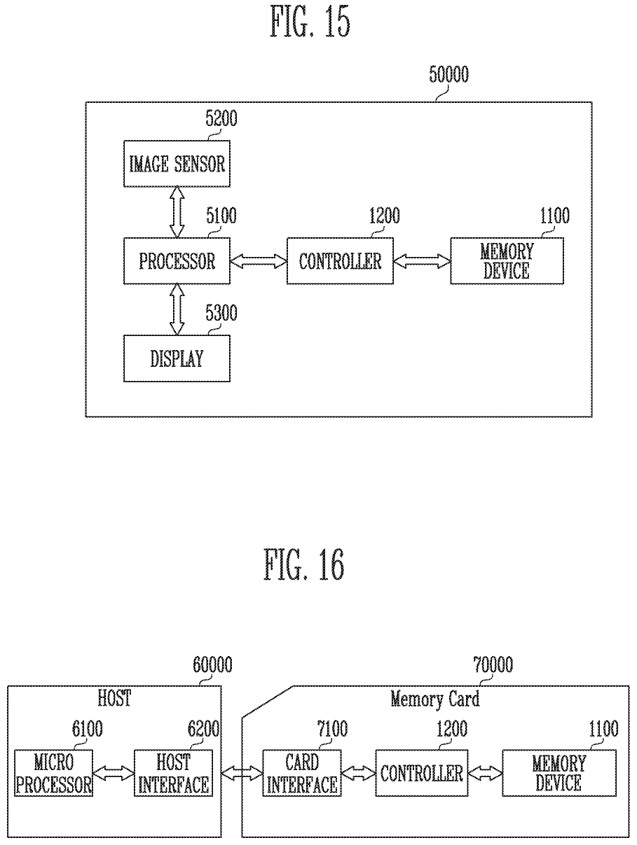

FIG. 15 is a diagram illustrating a memory system 50000 according to an embodiment of the present disclosure.

Referring to FIG. 15, the memory system 50000 may be embodied into an image processor, for example, a digital camera, a cellular phone with a digital camera attached thereto, a smart phone with a digital camera attached thereto, or a table PC with a digital camera attached thereto.

The memory system 50000 may include the memory device 1100 and the controller 1200 controlling a data processing operation of the memory device 1100, for example, a program operation, an erase operation, or a read operation.

An image sensor 5200 of the memory system 50000 may convert an optical image into digital signals. The converted digital signals may be transferred to the processor 5100 or the controller 1200. In response to control of the processor 5100, the converted digital signals may be output through the display 5300 or stored in the memory device 1100 through the controller 1200. In addition, the data stored in the memory device 1100 may be output through the display 5300 according to control of the processor 5100 or the controller 1200.

The controller 1200 may form a super block using some of the plurality of memory blocks included in the memory device 1100.

According to an embodiment, the controller 1200 for controlling the operations of the memory device 1100 may be formed as a part of the processor 5100, or a separate chip from the processor 5100. In addition, the controller 1200 may be formed through an example of the controller 1200 shown in FIG. 2.

FIG. 16 is a diagram illustrating a memory system 70000 according to an embodiment of the present disclosure.

Referring to FIG. 16, the memory system 70000 may include a memory card or a smart card. The memory system 70000 may include the memory device 1100, the memory controller 1200, and a card interface 7100.

The controller 1200 may form a super block using some of the plurality of memory blocks included in the memory device 1100.

The controller 1200 may control data exchange between the memory device 1100 and the card interface 7100. According to an embodiment, the card interface 7100 may be, but not limited thereto, a secure digital (SD) card interface or a multi-media card (MMC) interface. In addition, the controller 1200 may be formed through an example of the controller 1200 shown in FIG. 2.

The card interface 7100 may interface data exchange between a host 60000 and the controller 1200 according to a protocol of the host 60000. According to an embodiment, the card interface 7100 may support a Universal Serial Bus (USB) protocol and an InterChip (IC)-USB protocol. The card interface 7100 may refer to hardware capable of supporting a protocol which is used by the host 60000, software installed in the hardware, or a signal transmission method.

When the memory system 70000 is connected to an host interface 6200 of the host 60000 such as a PC, a tablet PC, a digital camera, a digital audio player, a cellular phone, a console video game hardware, or a digital set-top pox, the host interface 6200 may perform data communication with the memory device 1100 through the card interface 7100 and the controller 1200 in response to control of a microprocessor 6100.

According to embodiments of the present disclosure, since wear leveling may be performed based on an erase count of each of a plurality of memory blocks included in a super block, the life of each of the memory blocks may be efficiently managed, so that the life of a memory system may be improved.

It will be apparent to those skilled in the art that various modifications can be made to any of the above-described embodiments of the present invention without departing from the spirit or scope of the present disclosure. Thus, it is intended that the present invention cover all such modifications provided they come within the scope of the appended claims and their equivalents.

In the above-discussed embodiments, all steps may be selectively performed or skipped. In addition, the steps in each embodiment may not always be performed in regular order. Furthermore, the embodiments disclosed in the present specification and the drawings aim to enable those skilled in the art to practice the present invention, not to limit it.

In describing embodiments of the present disclosure with reference to the accompanying drawings, specific terms or words used should be construed in accordance with the spirit of the present disclosure without limiting the subject matter thereof. It should be understood that many variations and modifications of the basic inventive concept described herein will still fall within the spirit and scope of the present disclosure as defined in the accompanying claims and equivalents thereof.

What is claimed is:

1. A memory system, comprising:
a memory device including a plurality of semiconductor memories each including a plurality of memory blocks; and
a controller configuring a plurality of super blocks by grouping the plurality of memory blocks and controlling overall operations of each of the plurality of super blocks,
wherein the controller performs wear leveling on the basis of first erase counts, one for each of the plurality of super blocks, and
wherein the controller performs wear leveling on the basis of second erase counts, one for each of memory blocks in a super block in which a memory block becomes a bad block, among the plurality of super blocks.

2. The memory system of claim 1, wherein the first erase counts are obtained by counting, for each of the plurality of super blocks, a number of erases performed on the corresponding super block, and the second erase counts are obtained by counting, for each of memory blocks in the super block in which one of the memory blocks is a bad memory block, a number of erases performed on the corresponding memory block.

3. The memory system of claim 1, wherein the controller comprises:
a super block management module configuring the plurality of super blocks; and
a wear leveling management module performing the wear leveling on the basis of the first and second erase counts.

4. The memory system of claim 3, wherein, when a memory block in a target super block, among the plurality of super blocks, becomes a bad block, the super block management module reconfigures the target super block by replacing the bad block with a reserved block in a reserved block area of the memory device.

5. The memory system of claim 4, wherein the super block management module reconfigures the target super block by replacing the bad block with a free block not in the plurality of super blocks, among the plurality of memory blocks of the memory device, when the reserved block is not available.

6. The memory system of claim 5, wherein the free block is a memory block in an over-provisioning area of the memory device.

7. The memory system of claim 5, wherein the wear leveling management module obtains the first and second erase counts by counting the number of erases performed on the target super block before the bad block occurs, and by counting, for each of the memory blocks in the target super block, the number of erases performed on the corresponding memory block after the bad block occurs.

8. The memory system of claim 7, wherein the wear leveling management module initially sets the second erase count of the reserved block to 1 (one) and increases the second erase count as the number of erases performed on the reserved block increases.

9. The memory system of claim 7, wherein the wear leveling management module initially sets the second erase count of the free block to a previous erase count of the free block and increases the second erase count of the free block as the number of erases performed on the free block increases.

10. A memory system, comprising:
a plurality of semiconductor memories; and
a controller coupled to the plurality of semiconductor memories,
wherein the controller comprises a super block management module configuring a plurality of memory blocks included in the plurality of semiconductor memories as a plurality of super blocks, and
a wear leveling management module performing wear leveling on the basis of first erase counts, one for each of the plurality of super blocks, and
performing the wear leveling on the basis of second erase counts, one for each of memory blocks in a target super block in which a memory block becomes a bad block, among the plurality of super blocks.

11. The memory system of claim 10, wherein, when a memory block in the target super block becomes a bad block, the super block management module reconfigures the target super block by replacing the bad block with a reserved block in a reserved block area of the plurality of semiconductor memories.

12. The memory system of claim 11, wherein the super block management module reconfigures the target super block by replacing the bad block with a free block not in the plurality of super blocks, among the plurality of memory blocks, when the reserved block is not available.

13. The memory system of claim 12, wherein the free block is a memory block in an over-provisioning area of the plurality of semiconductor memories.

14. The memory system of claim 12, wherein the wear leveling management module obtains the first and second erase counts by counting the number of erases performed on the target super block before the bad block occurs, and by counting, for each of the memory blocks in the target super block, the number of erases performed on the corresponding memory block after the bad block occurs.

15. The memory system of claim 14, wherein the wear leveling management module manages the second erase count by initially setting the second erase count of the reserved block to 1 (one), and by increasing the second erase count as the number of erases performed on the reserved block increases.

16. The memory system of claim 14, wherein the wear leveling management module initially sets the second erase count of the free block to a previous erase count of the free block, and increases the second erase count of the free block as the number of erases performed on the free block increases.

17. A method of operating a memory system, the method comprising:
grouping a plurality of memory blocks in a plurality of semiconductor memories into a plurality of super blocks;
counting a number of erases performed on each of the plurality of super blocks to generate first erase counts, one for each of the plurality of super blocks, and performing wear leveling on the plurality of semiconductor memories on the basis of the first erase counts;
changing a first erase count of a target super block in which a memory block becomes a bad block, among the plurality of super blocks, to second erase counts, one for each of the memory blocks in the target super blocks; and
performing the wear leveling on the target super block on the basis of the second erase counts.

18. The method of claim 17, wherein, when the bad block occurs in the target super block, the target super block is reconfigured by replacing the bad block with a reserved block in a reserved block area of the plurality of semiconductor memories.

19. The method of claim 18, wherein the target super block is reconfigured by replacing the bad block with a free block not in the plurality of super blocks, among the plurality of memory blocks, when the reserved block is not available.

20. The method of claim 19, wherein the free block is a memory block included in an over-provisioning area of the plurality of semiconductor memories.

21. A method of operating a memory system, the method comprising:
grouping a plurality of memory blocks in a plurality of semiconductor memories into a plurality of super blocks;
obtaining first erase counts by counting a number of erases performed on each of the super blocks;
changing a first erase count of a target super block in which a memory block becomes a bad block, among the plurality of super blocks, to second erase counts, one for each of the memory blocks in the target super block; and
performing a garbage collection operation by selecting a memory block with a smallest second erase count, among memory blocks in the target super block, as a target memory block.
